(19) United States
(12) Patent Application Publication
(10) Pub. No.: US 2003/0231108 A1
(43) Pub. Date: Dec. 18, 2003

(54) Vehicle movement warning light system

(76) Inventor: Anthony Edward Robert Welch, Abbotsford (CA)

Correspondence Address: Anthony Edward Robert Welch, c/o Paul D. Gornall, Lawyer - Reg'd Patent & TM Agent, 1820 - 355 Burrard St., Vancouver, BC, V6C 2G8, CA

(21) Appl. No.: 10/170,700

(22) Filed: Jun. 14, 2002

(51) Int. Cl. B60Q 1/22

(52) U.S. Cl. 340/463

(57) ABSTRACT

A vehicle is provided with front warning lights adjacent to the front corners of the vehicle. When the vehicle's brake is released, the lights adjacent to the front corner flash red to warn that the vehicle is about to move, or has begun to move. The lights can be coloured light emitting diodes within a lens, or the lens could be coloured red over a white light bulb. The front warning lights electrical circuit can be connected in parallel with the daytime running lights circuit, such that the front warning lights can only be activated when the ignition circuit is on. A release of the brake pedal deactivates the rear brake lights and completes electrical circuit to activate the red front warning lights. Optionally, a set of green lights can be added to the system to flash green when the vehicle is stopping and when the vehicle has stopped, thereby signaling to other vehicles at an intersection that those vehicles could safely cross in front of the vehicle until the front warning lights change from green to red.

### FIELD OF THE INVENTION

This invention relates to safety lighting systems for motor vehicles. In particular, it relates to warning systems that indicate a vehicle's change from a braking state to an accelerating state.

### BACKGROUND OF THE INVENTION

There exist numerous warning light systems for motor vehicles. Vehicle equipped for use on roads in traffic have brake lights on the rear of the vehicle that light to show activation of the brake pedal. Headlights on the front of the vehicle not only illuminate the road for the driver of the vehicle, but also warn other drivers of the vehicle's use and forward orientation. Turn signals are activated to indicate an intention to turn the vehicle. There also exist more sophisticated systems that are not in common use that indicate, for example, the engagement of the accelerator pedal, the speed of the vehicle, or an intention to move forward, with indicator lights located in highly visible locations on the vehicle such as the roof, the hood, the front grill, or the front corners of the vehicle. Previous systems however, have not integrated typical traffic light colour signalling patterns onto a vehicle's own recognizable warning lights, with red or amber LEDs warning that the vehicle is about to move forward or is in the process of moving forward, and green LEDs on the vehicle indicating to other vehicle drivers that they could proceed in front of the vehicle.

### SUMMARY OF THE INVENTION

A vehicle is provided with front warning lights adjacent to the front corners of the vehicle. When the vehicle's brake is released, the lights adjacent to the front corner flash red, amber, or a combination of red and amber to warn that the vehicle is about to move, or has begun to move. The lights can be coloured light emitting diodes within a lens, or the lens could be coloured red or amber over a white light bulb. The front warning lights electrical circuit can be connected in parallel with the daytime running lights circuit, such that the front warning lights can only be activated when the ignition circuit is on. A release of the brake pedal deactivates the rear brake lights and completes an electrical circuit to activate the red or amber front warning lights. Optionally, a set of green lights can be added to the system to flash green when the vehicle is stopping and when the vehicle has stopped, thereby signaling to other vehicles at an intersection that those vehicles could safely cross in front of the vehicle, until the front warning lights change from green to the red/amber state.

The invention is thus a vehicle frontal movement warning system comprising warning lights that emit light in a colour in the wavelength range of amber to red, mounted on a front portion of a vehicle that turn on when a brake device for the vehicle is released. The vehicle movement warning system would preferably have the warning lights are mounted adjacent to front corners of the vehicle to provide warning to the front and to the side of the vehicle. An enhanced embodiment of the invention would include the following additional features:

a) the warning lights comprise a pair of banks of light emitting diodes, mounted on the front left and right corners of a vehicle respectively;

b) individual light emitting diodes flash in sequence within each of the banks;

c) the banks of light emitting diodes emit a combination of red and amber light.

d) there are additionally green safety lights, mounted to the front of a vehicle, that are activated when a braking device is engaged;

e) the green safety lights comprise a pair of additional banks of light emitting diodes mounted adjacent to the vehicle's right and the left front corners respectively;

f) there is an intensity control module for the warning lights that increases the light intensity of the warning lights when an accelerator control for the vehicle is activated.

The enhanced system will thus provide excellent warning of forward movement or imminent forward movement of the vehicle, without the lights that convey the warning being confused with fixed traffic signal lights mounted at an intersection, with rear brake lights, or with the front turn signals of the vehicle.

### DESCRIPTION OF THE DRAWINGS

FIG. 1 is a front view of a vehicle having the vehicle movement warning light system of the present invention.

FIG. 2 is a traffic diagram showing the vehicle of FIG. 1 braking as it approaches an intersection.

FIG. 3 is a traffic diagram showing the vehicle of FIG. 2 stopped at the intersection with the vehicle's brakes still applied.

FIG. 4 is a traffic diagram showing the vehicle of FIG. 3 with its brake released, about to advance into the intersection.

FIG. 5 is a traffic diagram showing the vehicle of FIG. 4, with its accelerator pedal deeply pressed, advancing through the intersection.

FIG. 6 is a traffic diagram, showing the vehicle of FIG. 5 now almost advanced through the intersection and with its accelerator pedal lightly pressed to maintain speed.

FIG. 7 is a traffic diagram, showing the vehicle of FIG. 5 now advanced past the intersection and with its daytime running lights resumed.

FIG. 8 is a wiring diagram, showing the brake release means of activation of the red front warning lights of the vehicle movement warning system of the present invention.

FIG. 9 is a wiring diagram, showing the brake-applied means of activation of the optional green lights of the vehicle movement warning system of the present invention.

FIG. 10 is a wiring diagram, showing a timer and intensity control module for the vehicle movement warning system of FIG. 8.

FIG. 11 is a wiring diagram, showing a daytime running lights switch module integrated with the vehicle warning system of FIG. 9.

### DETAILED DESCRIPTION

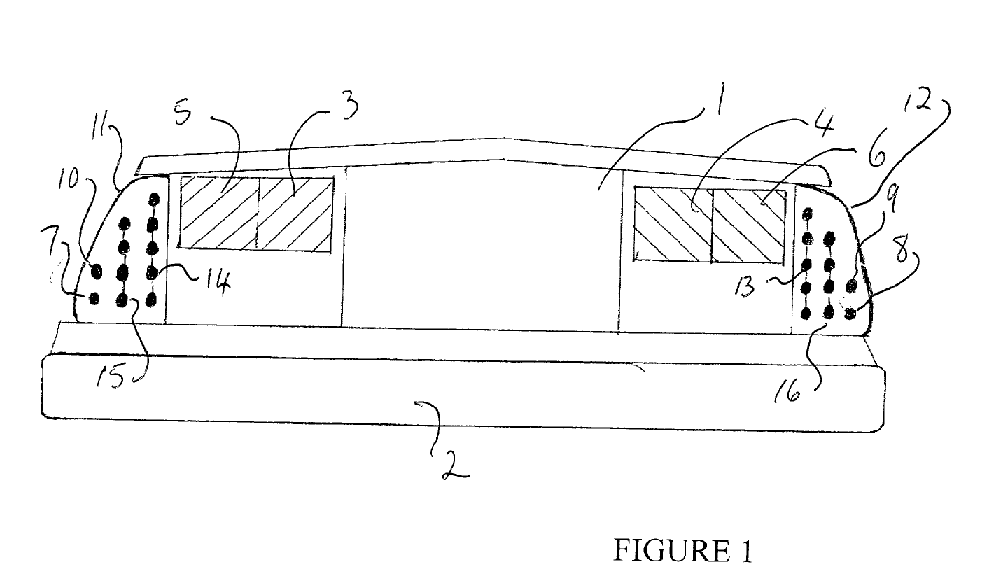

Referring to FIG. 1, the front of the vehicle 1 has a bumper 2, high beam headlights 3 and 4, low beam headlights 5 and 6, parking lights 7 and 8, left turn signal light 9, right turn signal light 10. Typically the turn signal lights are either amber coloured bulbs, or clear bulbs inside an amber coloured lens cover. In the presently shown configuration, the lens covers 11 and 12 are clear, because they also contain a bank of red LEDs (light emitting diodes) on the driver's side at 13 and on the passenger side at 14. Likewise, a bank of green LEDs on the driver's side at 15 and on the passenger side at 16 are contained within the lens covers 11 and 12 respectively. The red and green LED banks could be alternatively be mounted adjacent to the front turn signals, but outside of the amber turn signal lens cover.

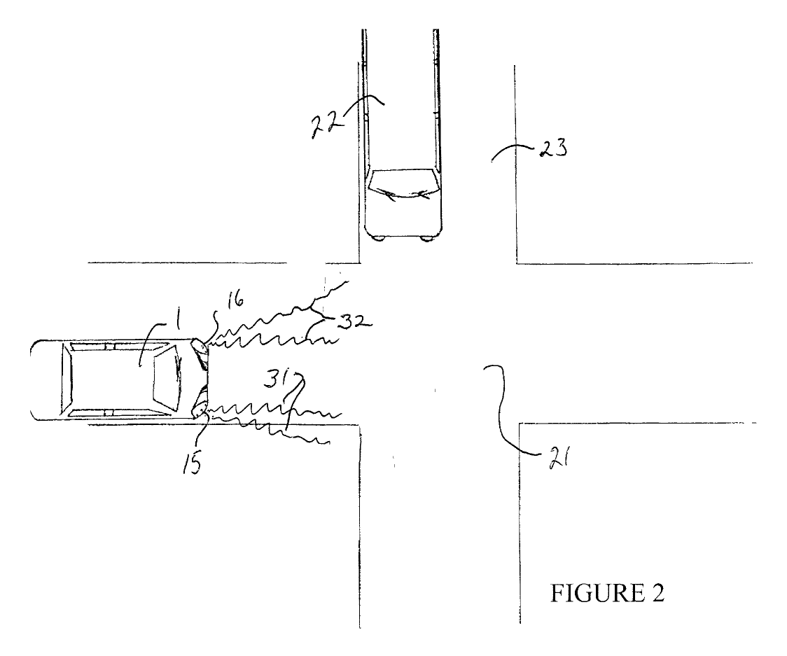

Referring to FIG. 2, when the vehicle 1 approaches the intersection 21, with a second vehicle 22 at the intersection cross-street 23, the brakes on vehicle 1 are applied, switching on the green LEDs 15 and 16, and sending green signal light 31 and 32 respectively to let the driver of the second vehicle 22 know that the vehicle 1 is braking and that the second vehicle 22 might proceed with safety if the intersection is uncontrolled, has a stop sign or a stop light for the vehicle 1 to obey.

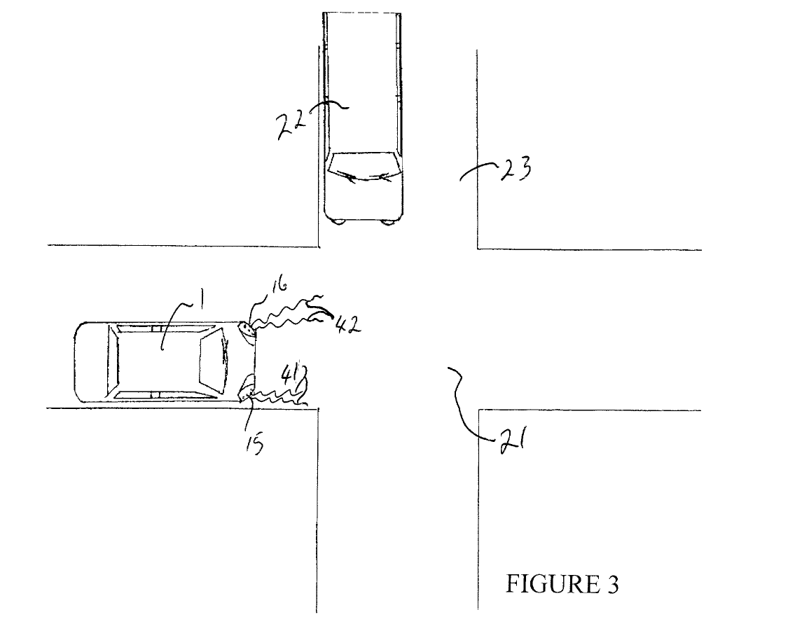

Referring to FIG. 3, the vehicle 1 has come to a stop but with the brakes still applied. Optionally a brake pressure sensor can be intregrated with a light intensifier module to modify the intensity of the green illumination from the green LEDs. Thus the green light at 41 and 42, from the passenger side bank of green LEDs 15 and from the driver's side bank of LEDs respectively, has been diminished to reflect the lesser braking force applied.

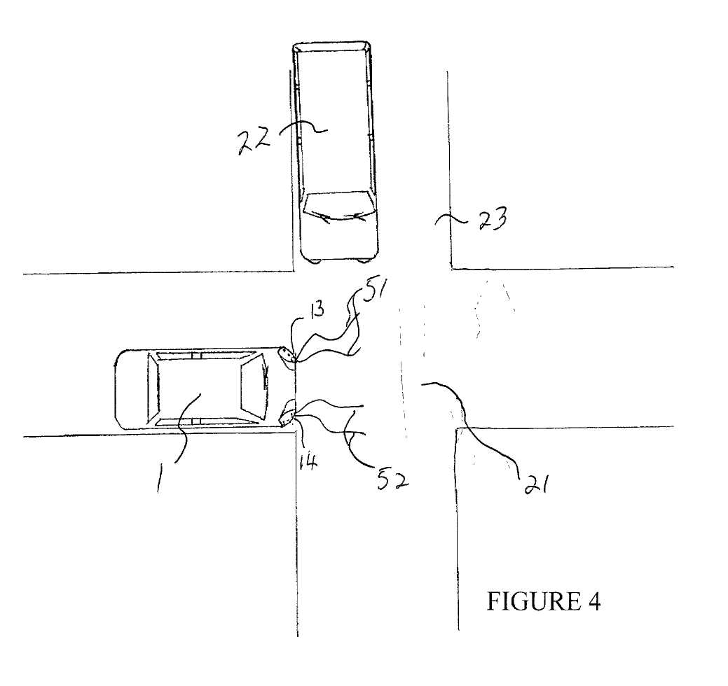

Referring to FIG. 4, when the brake on vehicle 1 is released, a switch deactivates the banks of green LEDs 15 and 16 and activates the banks of red LEDs 13 and 14, sending red illumination 51 and 52 respectively to warn the second vehicle 22 that the vehicle 1 is rolling forward and about to enter the intersection 21.

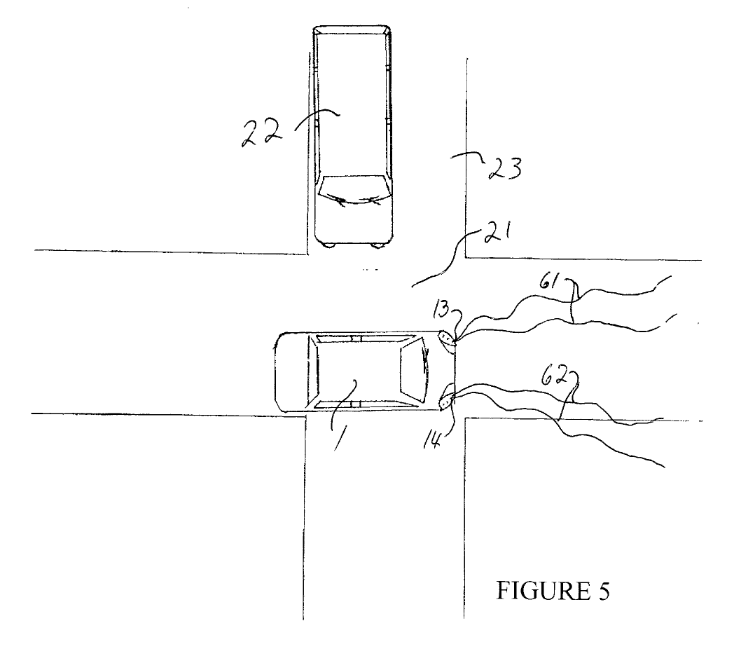

Referring to FIG. 5, optionally an intensity module can be integrated with the accelerator pedal, such that the banks of red LEDs 13 and 14 intensify their red illumination beams 61 and 62 when the accelerator pedal is depressed.

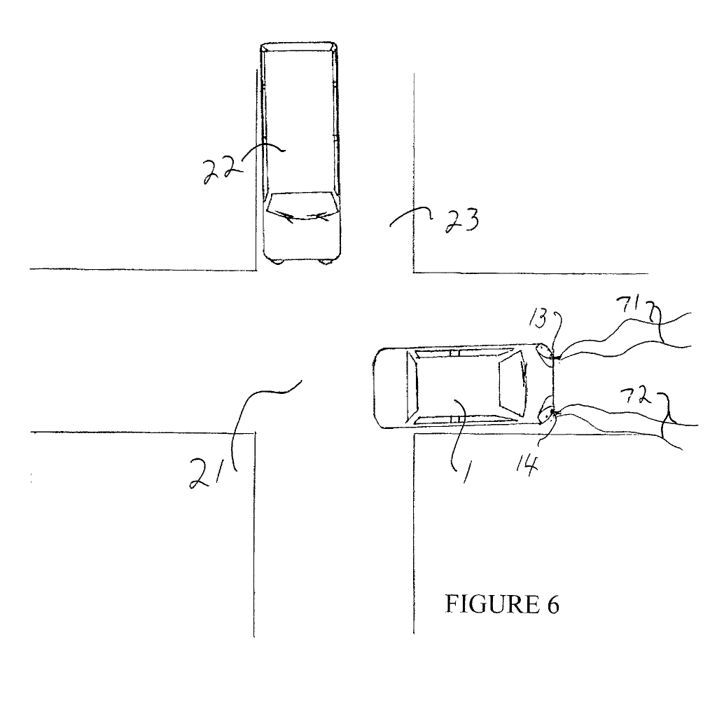

Referring to FIG. 6, the intensity module provides that the banks of red LEDs give moderate intensity red illumination beams 71 and 72 when the vehicle 1, now almost advanced through the intersection 21, has its accelerator pedal lightly pressed to maintain speed.

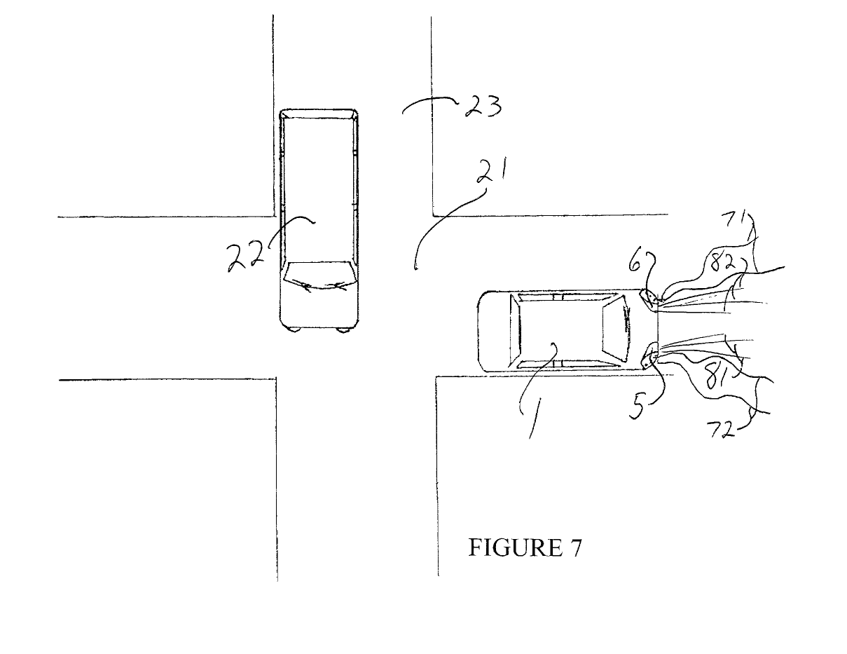

Referring to FIG. 7, the red illumination following the above-described sequence of safety and warning signals with the green to red illumination series can remain on as in FIG. 6, but with the daytime running lights from the low beam headlights 5 and 6 with their white beams 81 and 82 turned back on after the braking and accelerating sequence. At night, the low beam headlights would be on all the time, but in the daytime, they could be switched off when either the bank of green LEDs or the bank of red LEDs is on, in order to enhance the visibility of the change.

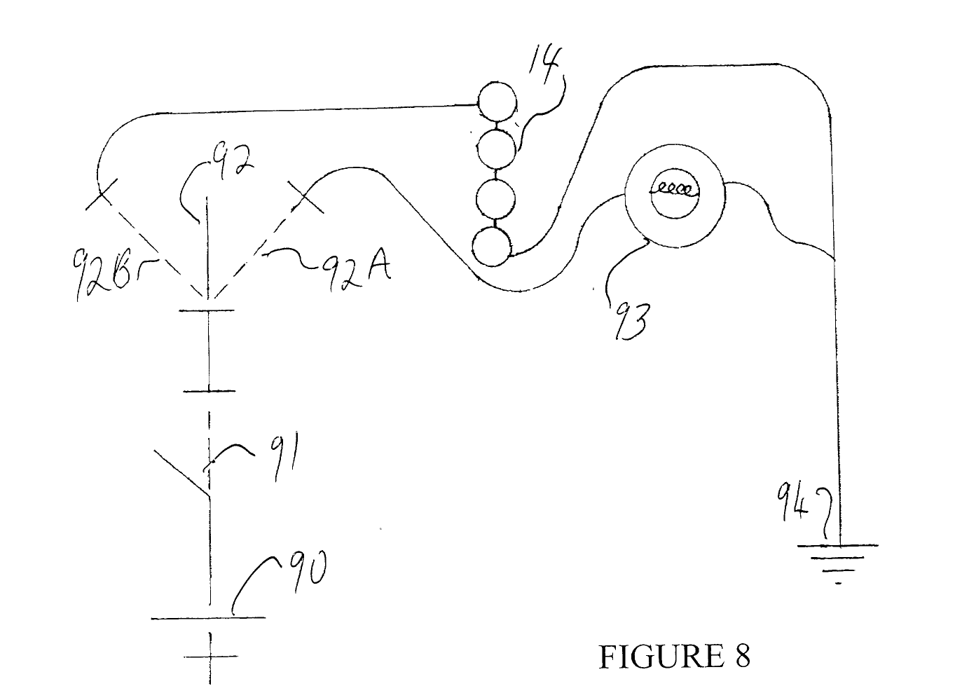

Referring to FIG. 8, the wiring diagram shows the brake release means of activation of the red front warning lights of the vehicle movement warning system. The electrical current proceeds from the positive battery terminal 90 through the ignition switch 91 to a brake position switch 92. When the brake is on (position 92A), the daytime running lights circuit 93 is activated. When the brake pedal is released (position 93), the bank of red LEDs 14 is activated. The negative battery terminal 94 completes the circuit to the vehicle's battery.

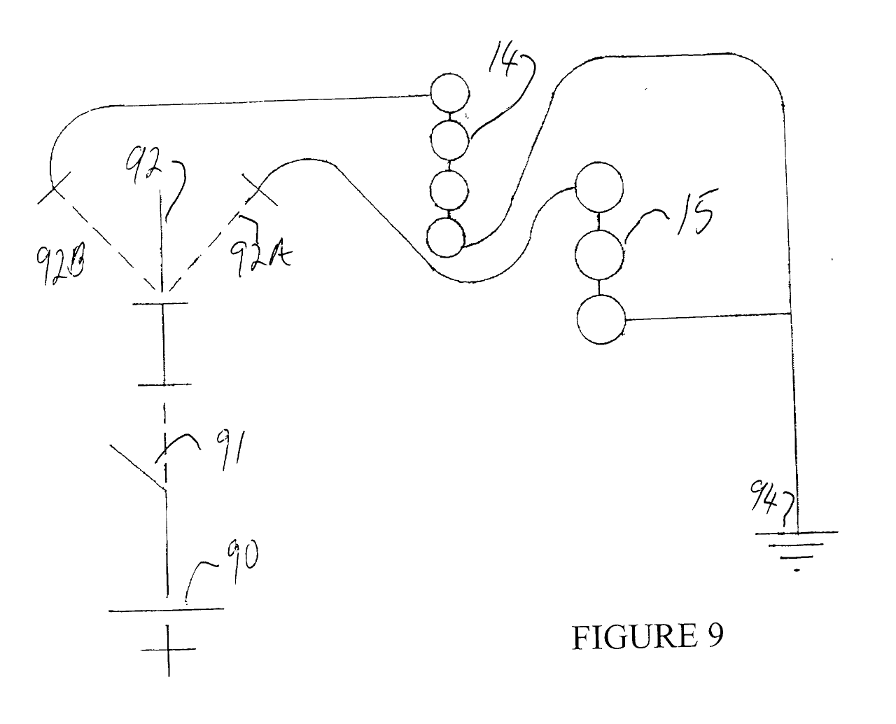

Referring to FIG. 9, the wiring diagram shows the brake-applied means of activation of the optional green lights of the vehicle movement warning system as well as the brake release means of activation of the red front warning lights of the vehicle movement warning system. The electrical current proceeds from the positive battery terminal 90 through the ignition switch 91 to a brake position switch 92. When the brake is on (position 92A), the bank of green LEDs 15 is activated. When the brake pedal is released (position 93), the bank of red LEDs 14 is activated. The negative battery terminal 94 completes the circuit to the vehicle's battery.

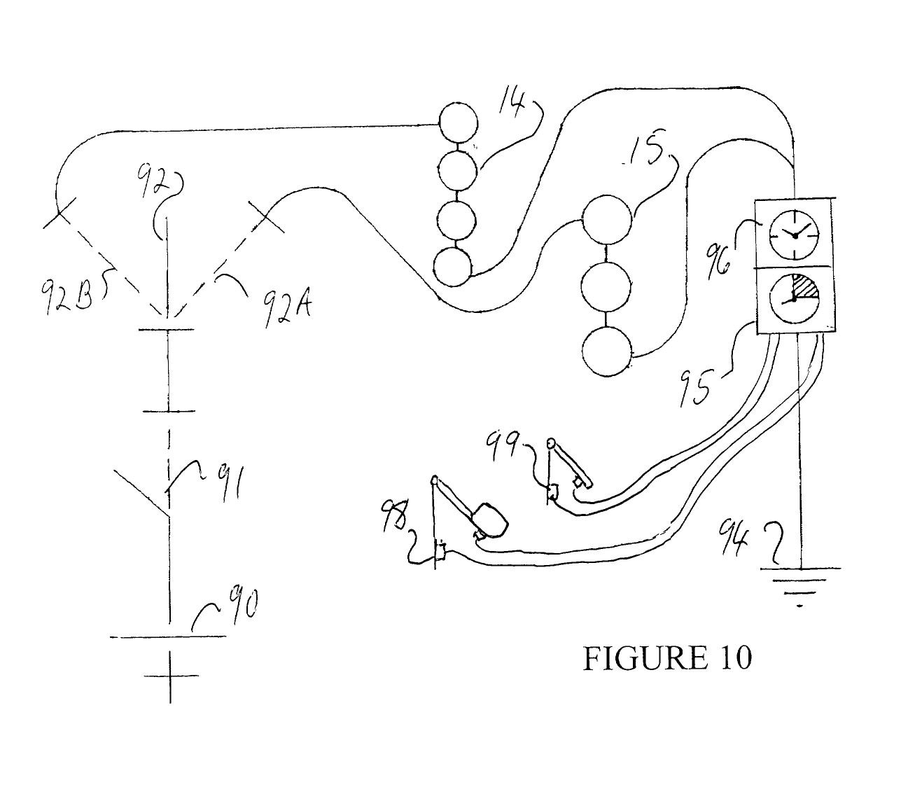

Referring to FIG. 10 an intensity control module 95 can be integrated into the vehicle movement warning system, to receive input from the brake pedal depression position sensor 98 and optionally from an accelerator pedal depression position sensor 99, and to adjust the intensity of the bank of red or green LEDs in accordingly. Thus the vehicle 1 as shown in FIG. 2 and 3 that has put on its brakes and then eased up on them can have the illumination from the banks of green LEDs turn on but then diminish. Likewise, when the brake on vehicle 1 is released as shown in FIG. 4 and the accelerator pressed with the result as shown in FIG. 5, and continuing to the state described in FIG. 6, the intensity control module receives information from the brake pedal depression position sensor 98 and the accelerator depression position sensor 99 accordingly and causes the switch from green LED illumination to a small degree of red illumination (FIG. 4—brake off), to more intense red (FIG. 5 accelerator depressed), and then to less intense red (FIG. 6—accelerator on).

Still referring to FIG. 10, a timer module 96 can cause even the less intense red of FIG. 6 to be turned off. This is useful to have the warning system operate during a braking, stopping, and taking off sequence, but not to otherwise display until the next intersection or other reason for the vehicle to stop and pause. The system is essentially a change of movement warning system. When the vehicle is not changing its speed by braking, the daytime running lights 93 can remain as sufficient warning that the vehicle is actually moving.

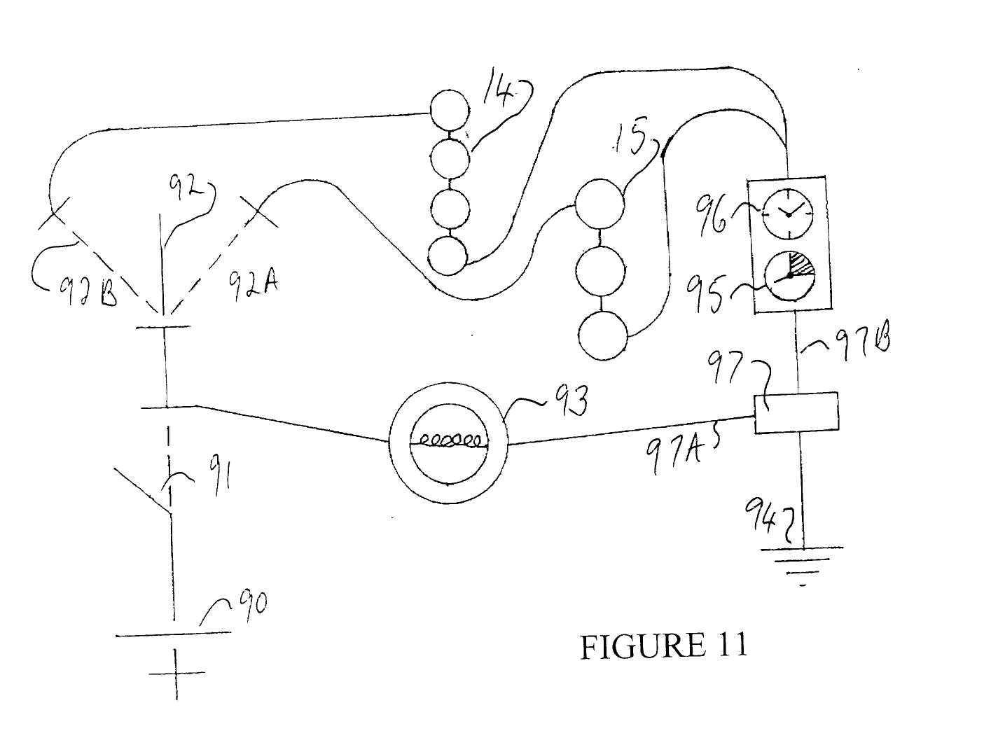

Referring to FIG. 11, the wiring diagram shows a daytime running lights control module 97 that is integrated with the vehicle warning system in order to have the low beam headlight system 97A turn off if it is daytime and the intensity circuit 97B from the bank of green LEDs 15 or the bank of red LEDs 14 is on.

It is envisioned that the vehicle movement warning system's red or amber LEDS (and optionally green LED's) will take advantage of the usual meaning of red or amber (and green) in traffic signals, but they will be sufficiently different that they will not be mistaken for traffic lights mounted at an intersection. The LED's can distinguish themselves by pulsing in unison within a bank or by individual LEDs flashing in sequence within the respective bank.

The use of a combination of red and amber lights on the front of the vehicle as described above, to warn that the vehicle is in motion or about to become moving, can be distinguished from the red brake lights on the rear of the vehicle not only by the LED look, the pulsing, and the sequencing options, but also by the addition of the amber in unison or in sequence with the red lights. The warning lights are likewise further distinguished from flashing amber turn signals by one or more of these features the LED look, the use of the red lights in unison or sequence with the amber, or the constant on of the amber during the warning signal.

I claim:

1. A vehicle movement warning system comprising warning lights that emit light in a colour in the wavelength range of amber to red, mounted on a front portion of a vehicle that turn on when a brake device for the vehicle is released.

2. The vehicle movement warning system of claim 1, in which the warning lights are mounted adjacent to front corners of the vehicle.

3. The vehicle movement warning system of claim 1, in which the warning lights comprise at least one light emitting diode.

4. The vehicle movement warning system of claim 1, in which the warning lights comprise at least one bank of light emitting diodes.

5. The vehicle movement warning system of claim 1, in which the warning lights flash in unison.

6. The vehicle movement warning system of claim 4, in which individual light emitting diodes flash in sequence within the bank.

7. The vehicle movement warning system of claim 2, in which the warning lights comprise a pair of banks of light emitting diodes mounted adjacent to the vehicle's right and the left front corners respectively.

8. The vehicle movement warning system of claim 1, in which the warning lights emit red light.

9. The vehicle movement warning system of claim 1, in which the warning lights emit amber light.

10. The vehicle movement warning system of claim 1, in which the warning lights emit a combination of red light and amber light.

11. The vehicle movement warning system of claim 1, further comprising green safety lights, mounted to the front of a vehicle, that are activated when a braking device is engaged.

12. The vehicle movement warning system of claim 11, in which the green safety lights comprise at least one light emitting diode.

13. The vehicle movement warning system of claim 11, in which the green safety lights comprise at least one bank of light emitting diodes.

14. The vehicle movement warning system of claim 11, in which the green safety lights flash in unison.

15. The vehicle movement warning system of claim 11, in which the green safety lights comprise at least one bank of individual light emitting diodes that flash in sequence within the bank.

16. The vehicle movement warning system of claim 11, in which the green safety lights comprise at least one bank of light emitting diodes.

17. The vehicle movement warning system of claim 11, in which the green safety lights comprise a pair of banks of light emitting diodes mounted adjacent to the vehicle's right and the left front corners respectively.

18. The vehicle movement warning system of claim 1, further comprising an intensity control module for the warning lights that increases the light intensity of the warning lights when an accelerator control for the vehicle is activated.

19. The vehicle movement warning system of claim 18, in which the intensity control module for the warning lights increases the light intensity of the warning lights in proportion to a degree of depression of the accelerator control for the vehicle.

20. The vehicle movement warning system of claim 18, further comprising a timer module that shuts off a vehicle's daytime running lights upon the warning lights being activated and reactivates the daytime running lights a period of time thereafter.

21. The vehicle movement warning system of claim 2, in which:
a) the warning lights comprise a pair of banks of light emitting diodes, mounted on the front left and right corners of a vehicle respectively;
b) individual light emitting diodes flash in sequence within each of the banks;
c) the banks of light emitting diodes emit a combination of red and amber light.
d) there are additionally green safety lights, mounted to the front of a vehicle, that are activated when a braking device is engaged;
e) the green safety lights comprise a pair of additional banks of light emitting diodes mounted adjacent to the vehicle's right and the left front corners respectively;
f) there is an intensity control module for the warning lights that increases the light intensity of the warning lights when an accelerator control for the vehicle is activated.
